(19) United States
(12) Patent Application Publication
(10) Pub. No.: US 2015/0224901 A1
(43) Pub. Date: Aug. 13, 2015

(54) SEAT FRAME

(71) Applicant: TS TECH CO., LTD., Asaka-shi, Saitama (JP)

(72) Inventor: Masaya Furuta, Shioya-gun (JP)

(21) Appl. No.: 14/429,714

(22) PCT Filed: Sep. 11, 2013
(86) PCT No.: PCT/JP2013/074463

§ 371 Date: Mar. 19, 2015

(30) Foreign Application Priority Data
Sep. 24, 2012 (JP) 2012-210026

(51) Int. Cl. B60N 2/68; B60N 2/22; B60N 2/48; B60N 2/70

(52) U.S. Cl. CPC B60N 2/682; B60N 2/7094; B60N 2/22; B60N 2/48

(57) ABSTRACT

A vehicle seat frame includes a resin first frame segment and a resin second frame segment. The first and second frame segments constitute a closed cross-sectional structure. The first frame segment has protrusions protruding toward the second frame segment. The protrusions are in contact with the second frame segment so as to provide a space between the first and second frame segments. The space is filled with an adhesive.

### TECHNICAL FIELD

The present invention relates to a seat frame.

### BACKGROUND ART

Techniques are known to reduce the weight of vehicle seats by partly or entirely making the frames of the vehicle seats of fiber reinforced plastic (for example, see Patent Literature 1).

### CITATION LIST

### Patent Literature

### Patent Literature 1: Japanese Unexamined Patent Application Publication No. 11-75984

### SUMMARY OF INVENTION

### Technical Problem

Some vehicle seat frames have hollow closed cross-sectional structures to have high strength and light weight. Unfortunately, a closed cross-sectional structure cannot readily be completed by an extrusion process at once due to complicated shapes of vehicle seat frames. The closed cross-sectional structure is therefore composed of two frame segments bonded with an adhesive, each having a cross section with an open end, i.e., an open cross-sectional structure.

A layer of the adhesive, however, may not have a desired thickness as designed because an even space is barely kept between target surfaces of the two frame segments during the bonding process. This may result in an uneven thickness of the layer of the adhesive, unbonded regions, and low adhesion strength.

An object of the present invention, which has been made to solve the problem, is to keep an even space between the target surfaces of these two frame segments during the bonding process.

### Solution to Problem

In order to solve the above problems, the invention of claim 1 is a seat frame having a closed cross-sectional structure, including a first frame segment, and a second frame segment, wherein the first and second frame segments comprising resin and bonded to each other to constitute the closed cross-sectional structure, the first frame segment has a protrusion protruding toward the second frame segment and being in contact with the second frame segment so as to provide a space between the first and second frame segments, and the space is filled with an adhesive.

The invention of claim 2 is the seat frame according to claim 1, wherein the first frame segment has an open cross-sectional structure having a transverse section with an opening at the back and extending vertically, the second frame segment has an open cross-sectional structure having a transverse section with an opening at the front and extending vertically, the open cross-sectional structure of the first frame segment is fit in the opening of the open cross-sectional structure of the second frame segment such that the opening of the open cross-sectional structure of the first frame segment faces the opening of the open cross-sectional structure of the second frame segment, and the open cross-sectional structure of the first frame segment has the protrusion protruding outward and toward the open cross-sectional structure of the second frame segment and being in contact with the open cross-sectional structure of the second frame segment to provide the space between the open cross-sectional structure of the first frame segment and the open cross-sectional structure of the second frame segment.

The invention of claim 3 is the seat frame according to claim 2, wherein the protrusion extends in a front-back direction.

The invention of claim 4 is the seat frame according to claim 2 or 3, wherein at least one of the open cross-sectional structures of the first and second frame segments comprises a spring holder holding a spring, and a vertical position of the protrusion is shifted from a vertical position of the spring holder.

The invention of claim 5 is the seat frame according to claim 1, wherein the second frame segment has an open cross-sectional structure having a longitudinal section with an opening at the front and extending horizontally, the first frame segment comprises a plate-like cover fitting in the opening of the open cross-sectional structure of the second frame segment, the cover has a bulge protruding toward the open cross-sectional structure of the second frame segment and being in contact with the open cross-sectional structure of the second frame segment to provide the space between the cover and the open cross-sectional structure of the second frame segment, the cover has an overhang, and the bulge is coupled to the overhang.

The invention of claim 6 is the seat frame according to claim 1, wherein the first frame segment comprises a headrest stay support having an open cross-sectional structure opened at the back and extending vertically, and projections are disposed along side surfaces of the headrest stay support and are in contact with the second frame segment to block the adhesive.

The invention of claim 7 is the seat frame according to claim 1, wherein the first frame segment has a frame-like open cross-sectional structure having a longitudinal section with an opening at the top, the second frame has a frame-like open cross-sectional structure having a longitudinal section with an opening at the bottom, the open cross-sectional structure of the first frame segment is fit in the opening of the open cross-sectional structure of the second frame segment such that the opening of the open cross-sectional structure of the first frame segment faces the opening of the open cross-sectional structure of the second frame segment, the open cross-sectional structure of the first frame segment has the protrusion protruding outward and toward the open cross-sectional structure of the second frame segment and being in contact with the open cross-sectional structure of the second frame segment to provide the space between the open cross-sectional structure of the first frame segment and the open cross-sectional structure of the second frame segment.

The invention of claim 8 is the seat frame according to claim 7, wherein the protrusion extends vertically.

### Advantageous Effects of Invention

According to the invention of claim 1, the protrusion is in contact with the second frame segment. Hence, an even space is provided between the first and second frame segments. Such a configuration reduces the risk of an uneven thickness of the layer of the adhesive in the space, unbonded regions, and low adhesive strength. As a result, the first and second frame segments are bonded strongly.

According to the invention of claim 2, the open cross-sectional structure of the first frame segment is fit in the opening of the open cross-sectional structure of the second frame segment and has protrusions. Hence, the protrusion is covered with the open cross-sectional structure of the second frame segment. Such a configuration reduces the risk of snagging the cushion pad on the protrusion while covering the frame with the cushion pad, which facilitates the mounting of the frame and the cushion pad.

According to the invention of claim 3, the protrusion extends horizontally. Hence, the open cross-sectional structures of the first and second frame segments have high rigidity to withstand torsional load.

According to the invention of claim 4, the position of the protrusion is vertically (up and down) shifted from the position of the spring holder. Hence, bonded areas of the first and second frame segments receive tensile load from the spring.

According to the invention of claim 5, the bulge is coupled to the overhang. Hence, the cover of the first frame segment has high rigidity.

According to the invention of claim 6, the projections are in contact with the second frame segment. Hence, the headrest stay support has high rigidity. The projections block the adhesive, keeping the adhesive from flowing into the open cross-sectional structure of the headrest stay support. Such a configuration reduces the risk that the adhesive hinders the mounting of the headrest stay holder on the headrest stay support.

According to the invention of claim 7, the open cross-sectional structure of the first frame segment is fit in the opening of the open cross-sectional structure of the second frame segment and has protrusions. Hence, the protrusion is covered. with the open cross-sectional structure of the second frame segment. Such a configuration reduces the risk of snagging the cushion pad on the protrusions while covering the frame with the cushion pad, which facilitates the mounting of the frame and the cushion pad.

According to the invention of claim 8, the protrusion extends vertically. Hence, the open cross-sectional structures of the first and second frame segments have high rigidity to withstand torsional load.

### BRIEF DESCRIPTION OF DRAWINGS

FIG. 1 is a side view of a seat according to an embodiment of the present invention.

FIG. 2 is a perspective view of a backrest frame according to the embodiment of the present invention.

FIG. 3 is a transverse sectional view taken along line in FIG. 2, viewed from above.

FIG. 4 is a perspective view of an outer frame segment of the backrest frame according to the embodiment of the present invention.

FIG. 5 is a perspective view of an inner frame segment of the backrest frame according to the embodiment of the present invention.

FIG. 6 is a longitudinal sectional view taken along line VI-VI in FIG. 2, viewed from the front.

FIG. 7 is a transverse sectional view taken along line VII-VII in FIG. 2, viewed from above.

FIG. 8 is a transverse sectional view taken along line VIII-VIII in FIG. 2, viewed from above.

FIG. 9 is a longitudinal sectional view of a bottom seat frame taken along line IX-IX in FIG. 1, viewed in the direction of the arrows.

FIG. 10 is a transverse sectional view of the bottom seat frame taken along line X-X in FIG. 9, viewed in the direction of the arrows.

### DESCRIPTION OF EMBODIMENTS

Embodiments of the present invention will now be described with reference to the accompanying drawings. Although the following embodiments include various limitations that are technically preferred in the practice of the present invention, the scope of the present invention is not limited to the embodiments or illustrated examples.

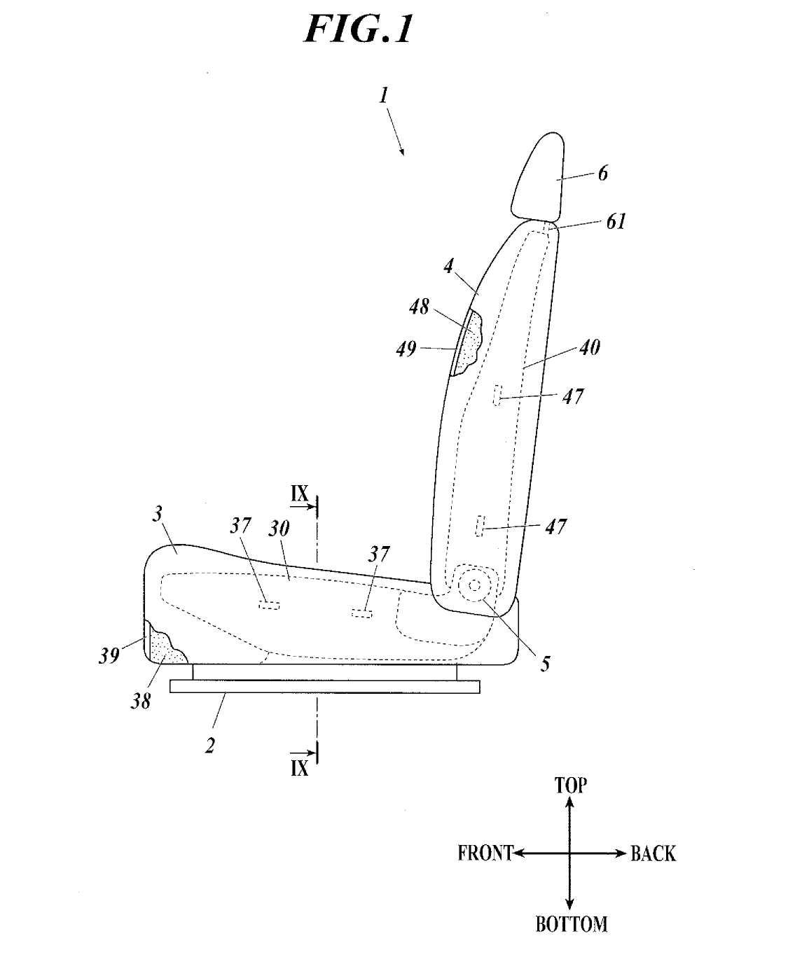

FIG. 1 is a side view of a seat 1. In the following description, right and left sides are determined by the view from the back side to the front side of the seat 1. That is, the right and left sides depend on the perspective of a person seated in the seat 1.

The seat 1 is a vehicle seat. In particular, the seat 1 is a vehicle seat provided in the interior of an automobile.

The seat 1 includes a slide rail 2, a bottom seat 3, a backrest 4, a recliner mechanism 5, and a headrest 6. The backrest 4 has a bottom end coupled to the rear end of the bottom seat 3 via the recliner mechanism 5. The backrest 4 stands on the rear end of the bottom seat 3. The headrest 6 is mounted on the top end of the backrest 4. The recliner mechanism 5 allows the backrest 4 to tilt in the front-back direction with respect to the bottom seat 3. The recliner mechanism 5 stops tilting of the backrest 4 by locking the backrest 4 to the bottom seat 3 and unlocks the backrest 4 to urge the backrest 4 forward. The headrest 6 has a pair of right and left headrest stays 61 extending downward, at the bottom end.

The bottom seat 3 has a frame 30, a spring 37, a cushion pad 38, and an outermost layer 39. When viewed from above, the frame 30 has the shape of a frame. The spring 37 is provided within the frame 30. The frame 30 and the spring 37 are covered with the cushion pad 38. The cushion pad 38 is covered with the outermost layer 39. The frame 30 is attached to the slide rail 2 which makes the bottom seat 3 movable in the front-back direction.

The backrest 4 has a frame 40, a spring 47, a cushion pad 48, and an outermost layer 49. When viewed from the front, the frame 40 has the shape of a frame. The spring 47 is provided within the frame 40. The frame 40 and the spring 47 are covered with the cushion pad 48. The cushion pad 48 is covered with the outermost layer 49. The frame 40 has a bottom end coupled to the recliner mechanism 5. The recliner mechanism 5 is coupled to the rear end of the frame 30. The recliner mechanism 5 makes the frame 40 movable in the front-back direction.

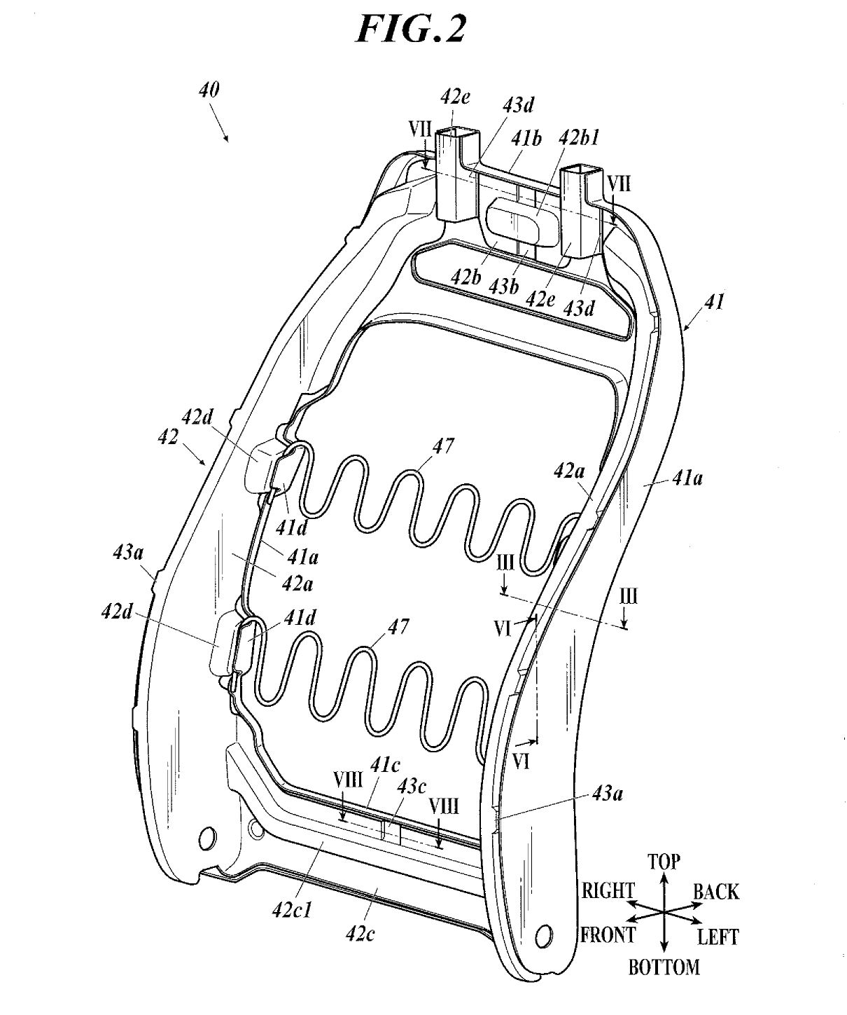

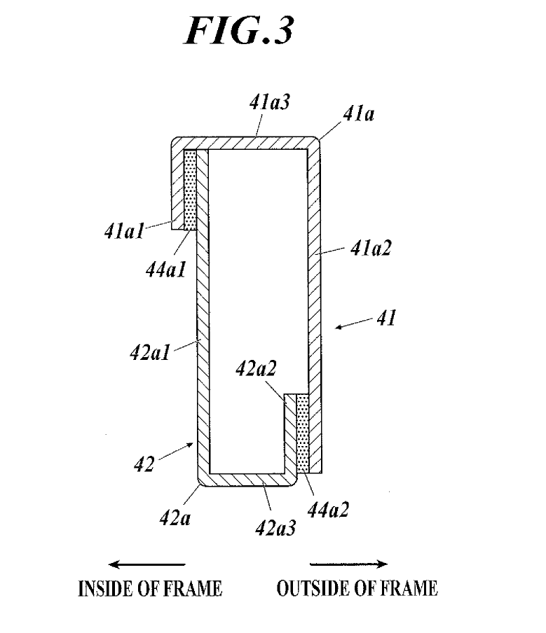

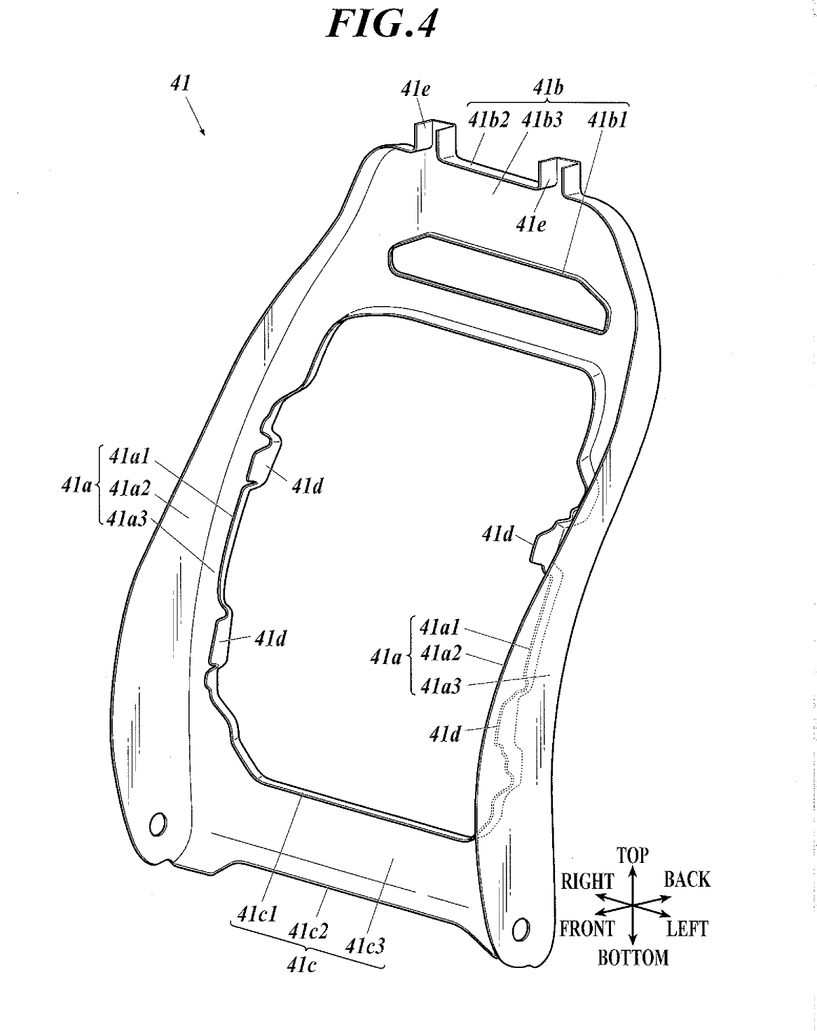

FIG. 2 is a perspective view of the frame 40. FIG. 3 is a transverse sectional view taken along line in FIG. 2, viewed in the direction of the arrows. FIG. 4 is a perspective view of the outer frame segment 41 of the frame 40. FIG. 5 is a perspective view of the inner frame segment 42 of the frame 40.

As shown in FIGS. 2 and 3, the frame 40 includes the outer frame segment 41 and the inner frame segment 42.

The outer frame segment 41 and the inner frame segment 42 are made of resin (for example, carbon fiber reinforced plastic, glass fiber reinforced plastic, and other fiber reinforced plastics). The outer frame segment 41 has an open cross-sectional structure opened at the front. The inner frame segment 42 is bonded to the outer frame segment 41 from the front side to be fit in the open cross-sectional structure of the outer frame segment 41. The outer frame segment 41 and the inner frame segment 42 are bonded with an adhesive and constitute a closed cross-sectional structure which forms the shape of a frame extending toward the front of the frame 40. The outer frame segment 41 and the inner frame segment 42 will now be described in detail.

As shown in FIG. 4, the outer frame segment 41 has a pair of right and left members 41a, an upper member 41b, and a lower member 41c to form the open cross-sectional structure.

Each of the right and left members 41a has an open cross-sectional structure which has a transverse section (along the horizontal direction) opened at the front. The transverse section is gate shaped (for example, angularly U-shaped, U-shaped, or hook-shaped). The right and left members 41a extend vertically and their open cross-sectional structures extend vertically. In particular, each of the right and left members 41a includes a web 41a3, an inner flange 41a1, and an outer flange 41a2 to form the open cross-sectional structure. The web 41a3 extends vertically. The inner flange 41a1 extends forward from the edge of the web 41a3 inside of the frame (“inside of the frame” means “inside of the frame composed of the inner and outer frame segments 41 and 42” throughout the specification) and extends vertically. The outer flange 41a2 extends forward from the edge of the web 41a3 outside of the frame (“outside of the frame” means “outside of the frame composed of the inner and outer frame segments 41 and 42” throughout the specification) and extends vertically.

The inner flange 41a1 of each of the right and left members 41a has spring holders 41d. The spring holders 41d extend from the inner flange 41a1 toward the inner side of the frame. Each inner flange 41a1 may have one or more spring holders 41d.

The upper member 41b has an open cross-sectional structure which has a longitudinal section along the front-back direction opened at the front. The longitudinal section is gate-shaped (for example, angularly U-shaped, U-shaped, or hook-shaped). The upper member 41b extends horizontally (right and left) and its open cross-sectional structure extends horizontally. In particular, the upper member 41b includes a web 41b3, an inner flange 41b1, and an outer flange 41b2 to form the open cross-sectional structure. The web 41b3 extends horizontally. The inner flange 41b1 extends forward from the edge of the web 41b3 inside of the frame and extends horizontally. The outer flange 41b2 extends forward from the edge of the web 41b3 outside of the frame and extends horizontally. The upper member 41b has right and left ends coupled to the top ends of the right and left members 41a. The right and left ends of the open cross-sectional structure formed by the upper member 41b are coupled to the top ends of the open cross-sectional structures of the right and left members 41a.

The upper member 41c has an open cross-sectional structure which has a longitudinal section along the front-back direction opened at the front. The longitudinal section is gate-shaped (for example, angularly U-shaped, U-shaped, or hook-shaped). The lower member 41c extends horizontally and its open cross-sectional structure extends horizontally. In particular, the lower member 41c includes a web 41c3, an inner flange 41c1, and an outer flange 41b2 to form the open cross-sectional structure. The web 41c3 extends horizontally. The inner flange 41c1 extends forward from the edge of the web 41c3 inside of the frame and extends horizontally. The outer flange 41b2 extends forward from the edge of the web 41b3 outside of the frame and extends vertically. The lower member 41c has right and left ends coupled to the bottom ends of the right and left members 41a. The right and left ends of the open cross-sectional structure formed by the lower member 41c are coupled to the bottom ends of the open cross-sectional structures of the right and left members 41a.

The upper member 41b has a pair of right and left headrest stay supports 41e at the top end. Each headrest stay support 41e has an open cross-sectional structure which has a transverse section (along the horizontal direction) opened at the front. The open cross-sectional structure extends vertically, and its transverse section is gate-shaped (for example, angularly U-shaped, U-shaped, or hook-shaped).

As shown in FIG. 5, the inner frame segment 42 has a pair of right and left members 42a to form an open cross-sectional structure, an upper cover 42b, and a lower cover 42c.

Each of the right and left members 42a has an open cross-sectional structure which has a transverse section (along the horizontal direction) opened at the back. The transverse section is gate-shaped (for example, angularly U-shaped, U-shaped, or hook-shaped). The right and left members 42a extend vertically and their open cross-sectional structures extend vertically. In particular, each of the right and left members 42a includes a web 42a3, an inner flange 42a1, and an outer flange 42a2 to form the open cross-sectional structure. The web 42a3 extends vertically. The inner flange 42a1 extends backward from the edge of the web 42a3 inside of the frame and extends vertically. The outer flange 42a2 extends backward from the edge of the web 42a3 outside of the frame and extends vertically.

The inner flange 42a1 of each of the right and left members 42a has spring holders 42d. The spring holders 42d extend from the inner flange 42a1 toward the inner side of the frame. Each inner flange 42a1 may have one or more spring holders 42d. Equal numbers of spring holders 42d and spring holders 41d are provided.

The upper cover 42b is a plate extending horizontally. The upper cover 42b has right and left ends coupled to the top ends of the right and left members 42a. The upper cover 42b has an overhang 42b1 on the front side and a recess of the overhang 42b1 on the back side.

The lower cover 42c is a plate extending horizontally. The lower cover 42c has right and left ends coupled to the bottom ends of the right and left members 42a. The lower cover 42c has an overhang 42c1 on the front side, and a recess of the overhang 42c1 on the back side. The overhang 42c1 extends horizontally.

The upper cover 42b has a pair of right and left headrest stay supports 42e. Each headrest stay support 42e has an open cross-sectional structure which has a transverse section (along the horizontal direction) opened at the back. The open cross-sectional structure extends vertically, and its transverse section is gate-shaped (for example, angularly U-shaped, U-shaped, or hook-shaped).

As described above, the inner frame segment 42 is bonded to the outer frame segment 41 to be fit in the open cross-sectional structure of the outer frame segment 41. One or both of the target surfaces for bonding of the inner and outer frame segments 41 and 42 have protrusions facing the corresponding target surfaces. The protrusion of one target surface in contact with the other target surface provides a space between the target surfaces. The space is filled with an adhesive which is cured. The following is the detailed description.

As shown in FIG. 5, the right and left members 42a of the inner frame segment 42 have a plurality of protrusions 43a that secure a layer of an adhesive. Specifically, these protrusions 43a are on the outer flanges 42a2 of the right and left members 42a and protrude toward the outer side of the frame. The protrusions 43a are shifted from the spring holders 42d. At least one of the protrusions 43a may be vertically flush with the corresponding spring holder 42d.

As shown in FIGS. 2 and 3, the openings of the open cross-sectional structures of the right and left members 41a of the outer frame segment 41 face the openings of the open cross-sectional structures of the right and left members 42a of the inner frame segment 42. In such a state, the right and left members 42a are fit in the openings of the open cross-sectional structures of the right and left members 41a. The inner flanges 41a1 of the right and left members 41a are disposed inside of the frame than the inner flanges 42a1 of the right and left members 42a. In this state, the inner flanges 41a1 and the inner flanges 42a1 are disposed side by side and are bonded with an adhesive 44a1. Similarly, the outer flanges 41a2 of the right and left members 41a are disposed outside of the frame than the outer flanges 42a2 of the right and left members 42a. In this state, the outer flanges 41a2 and the outer flanges 42a2 are disposed side by side and are bonded with an adhesive 44a2. The right member 41a and the right member 42a constitute a closed cross-sectional structure, while the left member 41a and the left member 42a constitute a closed cross-sectional structure. Each of the closed cross-sectional structures extends vertically and has a hollow. These closed cross-sectional structures serve as side frames of the frame 30.

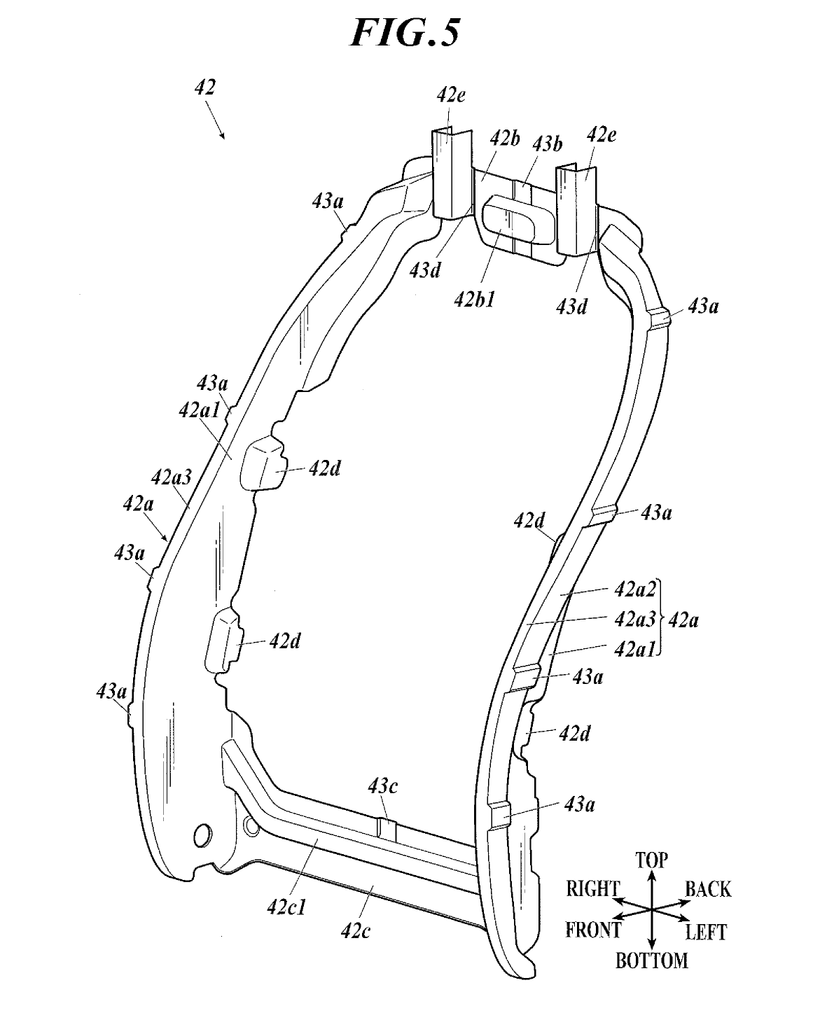

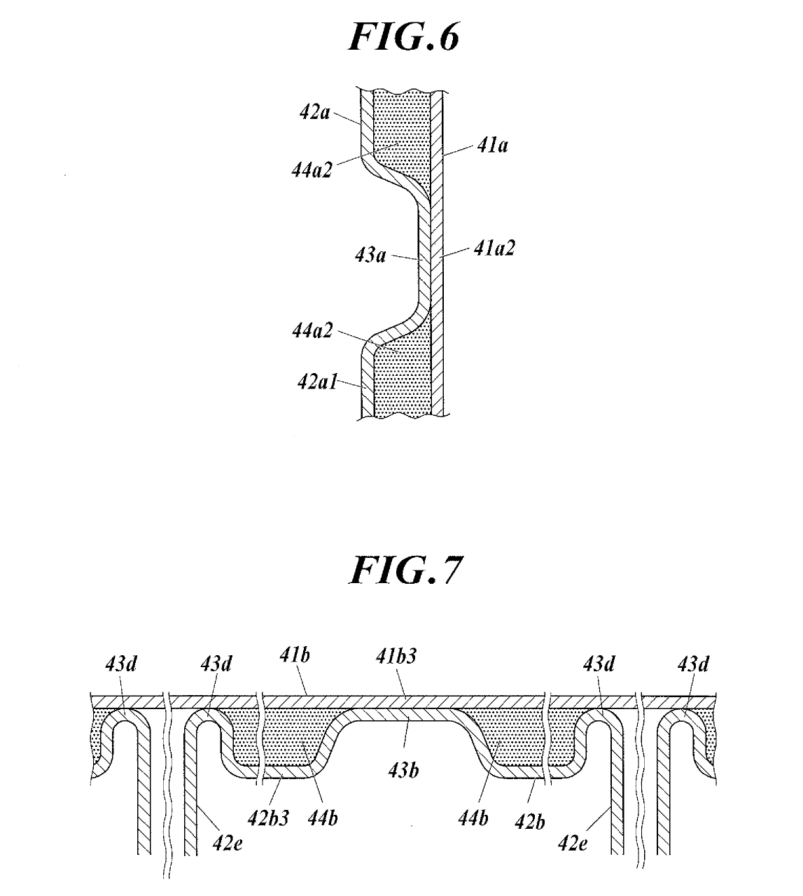

FIG. 6 is a longitudinal sectional view along the vertical direction taken along line VI-VI in FIG. 2, viewed in the direction of the arrows. As shown in FIG. 6, the protrusions 43a in contact with the outer flange 41a2 provide a space between the outer flanges 41a2 and 42a2. The space is filled with the adhesive 44a2. Alternatively, the outer flanges 41a2 of the right and left members 41a may have one or more protrusions that protrude toward the inner side of the frame and are in contact with the outer flange 42a2 so that a space to be filled with the adhesive 44a2 is provided between the outer flanges 41a2 and 42a2. Alternatively, the inner flanges 41a1 of the right and left members 41a may have one or more protrusions that protrude toward the outer side of the frame and are in contact with the inner flange 42a1 so that a space to be filled with the adhesive 44a1 is provided between the inner flanges 41a1 and 42a1. Alternatively, the inner flanges 42a1 of the right and left members 42a may have one or more protrusions that protrude toward the inner side of the frame and are in contact with the inner flange 41a1 so that a space to be filled with the adhesive 44a1 is provided between the inner flanges 41a1 and 42a1.

As shown in FIG. 5, a bulge 43b, which protrudes backward, is formed on the upper cover 42b of the inner frame segment 42. The bulge 43b extends vertically and is coupled to the overhang 42b1.

The upper cover 42b has projections 43d formed on both sides of each headrest stay support 42e. The projections 43d protrude backward. The projections 43d extend vertically along the side surfaces of the headrest stay supports 42e.

FIG. 7 is a transverse sectional view along the horizontal direction taken along line VII-VII in FIG. 2, viewed in the direction of the arrows. As shown in FIGS. 2 and 7, the upper cover 42b of the inner frame segment 42 is fit in the opening of the open cross-sectional structure of the upper member 41b so as to face the web 41b3 of the upper member 41b of the outer frame segment 41. The bulge 43b is in contact with the web 41b3 so as to provide a space between the upper cover 42b and the web 41b3. The space is filled with an adhesive 44b to bond the upper cover 42b and the web 41b3. The upper member 41b and the upper cover 42b constitute a closed cross-sectional structure that extends horizontally. The interior of the closed cross-sectional structure is filled with the adhesive 44b. Alternatively, the web 41b3 may have one or more bulges that protrude forward and are in contact with the upper cover 42b so that a space to be filled with the adhesive 44b is provided between the web 41b3 and the upper cover 42b.

The headrest stay support 42e is fit in the opening of the open cross-sectional structure of the headrest stay support 41e such that the opening of the open cross-sectional structure of the headrest stay support 41e and the opening of the open cross-sectional structure of the headrest stay support 42e face each other. The headrest stay support 42e faces the web 41b3. The projections 43d in contact with the web 41b3 block the adhesive 44b and keep the adhesive 44b from flowing into the headrest stay supports 41e and the headrest stay supports 42e. The headrest stay supports 41e and 42e and the web 41b3 form a hollow closed cross-sectional structure that vertically extends and contains a holder holding the headrest stay 61.

As shown in FIG. 5, a bulge 43c, which protrudes backward, is formed on the lower cover 42c of the inner frame segment 42. The bulge 43c extends vertically and is coupled to the overhang 42c1.

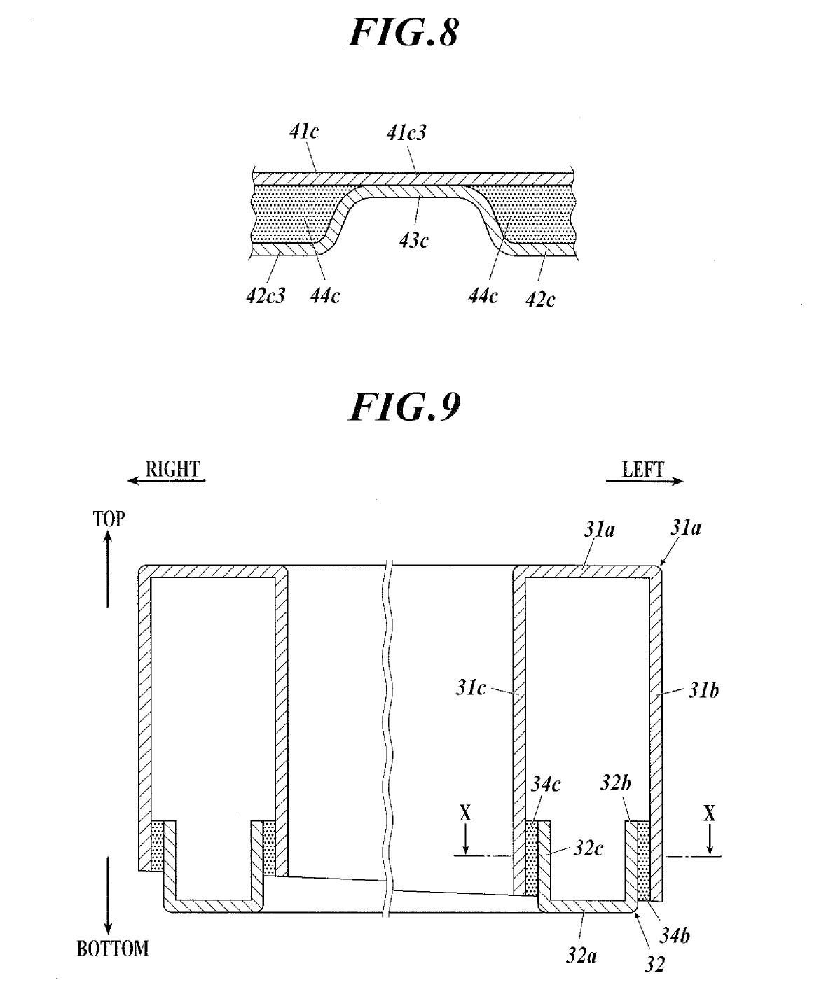

FIG. 8 is a transverse sectional view along the horizontal direction taken along line VIII-VIII in FIG. 2, viewed in the direction of the arrows. As shown in FIGS. 2 and 8, the lower cover 42c of the inner frame segment 42 is fit in the opening of the open cross-sectional structure of the lower member 41c so as to face the web 41c3 of the lower member 41c of the outer frame segment 41. The bulge 43c is in contact with the web 41c3 so as to provide a space between the lower cover 42c and the web 41c3. The space is filled with an adhesive 44c to bond the lower cover 42c and the web 41c3. The lower member 41c and the lower cover 42c constitute a closed cross-sectional structure that extends horizontally. The interior of the closed cross-sectional structure is filled with the adhesive 44c. Alternatively, the web 41c3 may have one or more bulges that protrude forward and are in contact with the lower cover 42c so that a space to be filled with the adhesive 44c is provided between the web 41c3 and the lower cover 42c.

As shown in FIG. 2, the spring holder 42d is disposed in front of the spring holder 41d for engagement. The spring holder 42d is bonded to the spring holder 41d with an adhesive. A corrugated spring 47 has one end hung on the left spring holders 41d and 42d and the other end hung on the right spring holders 41d and 42d, and thus is held between the left spring holders 41d and 42d, and the right spring holders 41d and 42d.

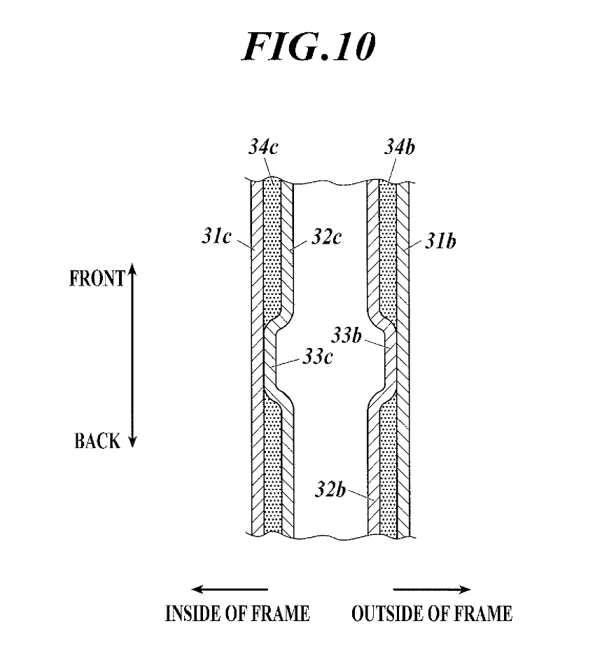

The frame 30 of the bottom seat 3 will now be described with reference to FIGS. 9 and 10. FIG. 9 is a cross sectional view of the frame 30 taken along line IX-IX in FIG. 1, viewed in the direction of the arrows. FIG. 10 is a cross sectional view of the frame 30 taken along line X-X in FIG. 9, viewed in the direction of the arrows.

As shown in FIGS. 9 and 10, the frame 30 includes an outer frame segment 31 and an inner frame segment 32. The outer and inner frame segments 31 and 32 are made of resin (for example, carbon fiber reinforced plastic, glass fiber reinforced plastic, and other fiber reinforced plastics).

The outer frame segment 31 has an open cross-sectional structure with a longitudinal section opened at the bottom. Viewed from the top or bottom, the outer frame segment 31 has the shape of a frame and has a frame-like open cross-sectional structure. In particular, the outer frame segment 31 includes a web 31a, an outer flange 31b, and an inner flange 31c to constitute the frame-like open cross-sectional structure. The outer flange 31b extends downward from the edge of the web 31a outside of the frame. The inner flange 31c extends downward from the edge of the web 31a inside of the frame.

The inner frame segment 32 has an open cross-sectional structure with a longitudinal section opened at the top. Viewed from the top or bottom, the inner frame segment 32 has the shape of a frame and has a frame-like open cross-sectional structure. In particular, the inner frame segment 32 includes a web 32a, an outer flange 32b, and an inner flange 32c to constitute the frame-like open cross-sectional structure. The outer flange 32b extends upward from the edge of the web 32a outside of the frame. The inner flange 32c extends upward from the edge of the web 32a inside of the frame.

The opening of the open cross-sectional structure of the outer frame segment 31 faces the opening of the open cross-sectional structure of the inner frame segment 32. In this state, the inner frame segment 32 is fit in the open cross-sectional structure of the outer frame segment 31 and is bonded to the bottom side of the outer frame segment 31 with adhesives 34b and 34c. The outer frame segment 31 and the inner frame segment 32 constitute a closed cross-sectional structure.

In particular, the outer flange 31b of the outer frame segment 31 is disposed outside of the frame than the outer flange 32b of the inner frame segment 32. In this state, the outer flange 31b is bonded to the outer flange 32b with the adhesive 34b. Similarly, the inner flange 31c of the outer frame segment 31 is disposed inside of the frame than the inner flange 32c of the inner frame segment 32. In this state, the inner flange 31c is bonded to the inner flange 32c with an adhesive 34c.

The outer flange 32b of the inner frame segment 32 has one or more protrusions 33b that protrude toward the outer side of the frame and are in contact with the outer flange 31b so that a space to be filled with the adhesive 34b is provided between the outer flanges 31b and 32b. Alternatively, the outer flange 31b of the outer frame segment 31 may have one or more protrusions that protrude toward the inner side of the frame and are in contact with the outer flange 32b so that a space to be filled with the adhesive 34b is provided between the outer flanges 31b and 32b.

The inner flange 32c of the inner frame segment 32 may have one or more protrusions 33c that protrude toward the inner side of the frame and are in contact with the inner flange 31c so that a space to be filled with the adhesive 34c is provided between the inner flanges 31c and 32c. Alternatively, the inner flange 31c of the outer frame segment 31 may have one or more protrusions that protrude toward the outer side of the frame and are in contact with the inner flange 32c so that a space to be filled with the adhesive 34c is provided between the inner flanges 31c and 32c.

The protrusions 33b and 33c extend vertically.

The embodiments of the present invention have the following advantageous effects.

(1) The outer flange 42a2 of the inner frame segment 42 has the protrusions 43a that are in contact with the outer flange 41a2 of the outer frame segment 41, which provides an even space between the outer flanges 42a2 and 41a2. This configuration reduces the risk of uneven thickness of the adhesive 44a2 in the space, unbonded regions, and low adhesive strength. As a result, the inner and outer frame segments 41 and 42 are bonded strongly. Similarly, the upper and lower covers 42b and 42c have bulges 43b and 43c, resulting in high adhesive strength between the inner and outer frame segments 42 and 41.

(2) The right and left members 42a of the inner frame segment 42 are fit in the openings of the right and left members 41a of the outer frame segment 41, and the outer flanges 42a2 of the right and left members 42a have protrusions 43a. Hence, the protrusions 43a are covered with the right and left members 41a of the outer frame segment 41. Similarly, bulges 43b and 43c are covered with the upper and lower members 41b and 41c of the outer frame segment 41. Such a configuration reduces the risk of snagging a cushion pad 38 on the protrusions 43a and the bulges 43b and 43c while covering the frame 40 with the cushion pad 38, which facilitates the mounting of the frame 40 and the cushion pad 38.

(3) Since the protrusions 43a extend horizontally (backwards and frontwards), the right and left members 41a and 42a have high rigidity to withstand torsional load.

(4) Since the vertical positions of the protrusions 43a are shifted from the vertical positions of the spring holders 41d and 42d, bonded areas of the outer frame segment 41 and the inner frame segment 42 receive tensile load from the spring 47. The following is the detailed explanation. Since the protrusions 43a are in contact with the outer flange 41a2 of the outer frame segment 41 without being directly bonded to the outer flange 41a2 of the outer frame segment 41, the unbonded areas would receive the heaviest tensile load from the spring 47 if the protrusions 43a are vertically flush with the spring holders 41d and 42d. In this embodiment, however, the protrusions 43a are vertically shifted from the spring holders 41d and 42d, and the unbonded areas barely receive tensile load from the spring 47.

(5) Since the bulges 43b and 43c of the upper and lower covers 42b and 42c are coupled to the overhangs 42b1 and 42c1, the covers 42b and 42c have high rigidity.

(6) The open cross-sectional structure of the inner frame segment 32 is fit in the opening of the open cross-sectional structure of the outer frame segment 31, and the flanges 32b and 32c of the open cross-sectional structure of the inner frame segment 32 have protrusions 33b and 33c. Hence, the protrusions 33b and 33c are covered with the open cross-sectional structure of the outer frame segment 31. Such a configuration reduces the risk of snagging the cushion pad 38 on the protrusions 33b and 33c while covering the frame 30 with the cushion pad 38, which facilitates the mounting of the frame 30 and the cushion pad 38.

(7) Since the protrusions 33b and 33c extend vertically, the open cross-sectional structures of the inner and outer frame segments 32 and 31 have high rigidity to withstand torsional load.

(8) The projections 43d disposed along the side surfaces of the headrest stay supports 42e increase the rigidity of the headrest stay supports 42e. The projections 43d and the web 41b3 are kept in contact with each other by the adhesive 44b, resulting in high rigidity of the headrest stay supports 41e and 42e.

(9) The projections 43d hold back the adhesive 44b, which keeps the adhesive 44b from flowing into the headrest stay supports 41e and 42e. Such a configuration reduces the risk that the adhesive 44b hinders the mounting of the headrest stay holder on the headrest stay supports 41e and 42e when the headrest stay holder is mounted to the headrest stay supports 41e and 42e.

### [Modifications]

The embodiments applicable to the present invention are not limited to those described above and may be modified as appropriate within the scope of the present invention. Several modifications will be described as follows. In these modifications, the details except for the modified points remain the same as in the embodiments described above. The following modifications may be used in combination.

(1) In the embodiments discussed above, the outer frame segment 41 has the spring holders 41d, and the inner frame segment 42 has the spring holders 42d. In a modification, the outer frame segment 41 has the spring holders 41d, while the inner frame segment 42 has no spring holder 42d. In another modification, the inner frame segment 42 has the spring holders 42d, while the outer frame segment 41 has no spring holder 41d.

(2) In the embodiments, the closed cross-sectional structure constituted by the right and left members 41a and 42a has a hollow. In a modification, the hollow may be filled with a filler (for example, a resin and an adhesive).

### INDUSTRIAL APPLICABILITY

The present invention is applicable to a frame having two resin frame segments bonded to each other.

### REFERENCE SIGNS LIST

1 seat
3 bottomrest
4 backrest
30 frame
31 outer frame segment (second frame segment)
32 inner frame segment (first frame segment)
33b, 33c protrusion
34c, 34b adhesive
40 frame
41 outer frame segment (second frame segment)
41a right and left members
41b upper member
41c lower member
41d spring holder
42 inner frame segment (first frame segment)
42a right and left members
42b upper cover
42b1 overhang
42c lower cover
42c1 overhang
42d spring holder
42e headrest stay support
43a protrusion
43b, 43c bulge
43d projection
44a1, 444a2, 44b, 44c adhesive
47 spring

1. A seat frame having a closed cross-sectional structure, comprising:
a first frame segment; and
a second frame segment, wherein
the first and second frame segments comprising resin and bonded to each other to constitute the closed cross-sectional structure,
the first frame segment has a protrusion protruding toward the second frame segment and being in contact with the second frame segment so as to provide a space between the first and second frame segments, and
the space is filled with an adhesive.

2. The seat frame according to claim 1, wherein
the first frame segment has an open cross-sectional structure having a transverse section with an opening at the back and extending vertically,
the second frame segment has an open cross-sectional structure having a transverse section with an opening at the front and extending vertically,
the open cross-sectional structure of the first frame segment is fit in the opening of the open cross-sectional structure of the second frame segment such that the opening of the open cross-sectional structure of the first frame segment faces the opening of the open cross-sectional structure of the second frame segment, and
the open cross-sectional structure of the first frame segment has the protrusion protruding outward and toward the open cross-sectional structure of the second frame segment and being in contact with the open cross-sectional structure of the second frame segment to provide the space between the open cross-sectional structure of the first frame segment and the open cross-sectional structure of the second frame segment.

3. The seat frame according to claim 2, wherein the protrusion extends in a front-back direction.

4. The seat frame according to claim 2, wherein
at least one of the open cross-sectional structures of the first and second frame segments comprises a spring holder holding a spring, and
a vertical position of the protrusion is shifted from a vertical position of the spring holder.

5. The seat frame according to claim 1, wherein
the second frame segment has an open cross-sectional structure having a longitudinal section with an opening at the front and extending horizontally,
the first frame segment comprises a plate-like cover fitting in the opening of the open cross-sectional structure of the second frame segment,
the cover has a bulge protruding toward the open cross-sectional structure of the second frame segment and being in contact with the open cross-sectional structure of the second frame segment to provide the space between the cover and the open cross-sectional structure of the second frame segment,
the cover has an overhang, and
the bulge is coupled to the overhang.

6. The seat frame according to claim 1, wherein
the first frame segment comprises a headrest stay support having an open cross-sectional structure opened at the back and extending vertically, and
projections are disposed along side surfaces of the headrest stay support and are in contact with the second frame segment to block the adhesive.

7. The seat frame according to claim 1, wherein
the first frame segment has a frame-like open cross-sectional structure having a longitudinal section with an opening at the top,
the second frame has a frame-like open cross-sectional structure having a longitudinal section with an opening at the bottom,
the open cross-sectional structure of the first frame segment is fit in the opening of the open cross-sectional structure of the second frame segment such that the opening of the open cross-sectional structure of the first frame segment faces the opening of the open cross-sectional structure of the second frame segment,
the open cross-sectional structure of the first frame segment has the protrusion protruding outward and toward the open cross-sectional structure of the second frame segment and being in contact with the open cross-sectional structure of the second frame segment to provide the space between the open cross-sectional structure of the first frame segment and the open cross-sectional structure of the second frame segment.

8. The seat frame according to claim 7, wherein the protrusion extends vertically.
